(19) United States
(12) Patent Application Publication
(10) Pub. No.: US 2025/0100380 A1
(43) Pub. Date: Mar. 27, 2025

(54) VEHICLE WINDOW, DISPLAY SYSTEM AND METHOD FOR CONTROLLING A VEHICLE WINDOW FOR AUTOMOTIVE VEHICLES

(71) Applicant: Harman Becker Automotive Systems GmbH, Karlsbad (DE)

(72) Inventors: Peter BRANDT, Pfinztal (DE); Joerg WELKE, Ettlingen-Schöllbronn (DE)

(73) Assignee: Harman Becker Automotive Systems GmbH, Karlsbad (DE)

(21) Appl. No.: 18/832,831

(22) PCT Filed: Mar. 15, 2022
(86) PCT No.: PCT/EP2022/056656

§ 371 Date: Jul. 24, 2024

(51) Int. Cl. B60K 35/22; B60K 35/25; B60K 35/28; B60K 35/60; B60K 35/81

(52) U.S. Cl. CPC B60K 35/22; B60K 35/25; B60K 35/28; B60K 35/60; B60K 35/81; B60K 2360/149; B60K 2360/1523; B60K 2360/178; B60K 2360/179; B60K 2360/332; B60K 2360/785

(57) ABSTRACT

The disclosure relates to a vehicle window, a display system, a method for controlling and manufacturing the vehicle window and an automotive vehicle. The vehicle window comprises a first transparent layer and at least a second transparent layer, wherein at least a first synthetical layer is arranged between the first transparent layer and the second transparent layer. Furthermore, at least one LED array is arranged between the first synthetical layer and the first transparent layer and covers at least a first area of the vehicle window. The LED array is configured to not emit light in a first operation mode and wherein the LED array is configured to at least partially emit light in at least a second operation mode.

### CROSS-REFERENCE TO RELATED APPLICATION

This application is the U.S. national phase of PCT Application No. PCT/EP2022/056656 filed on Mar. 15, 2022 the disclosure of which is hereby incorporated in its entirety by reference herein.

### FIELD

Various examples relate to a vehicle window, a display system and a method for controlling a vehicle window for automotive vehicles and the like.

### BACKGROUND

Automotive vehicles comprise several advanced assistance systems (ADAS) nowadays which assist the driver of the vehicle and are even capable of replacing certain tasks for driving. In accordance with that ongoing process of improving or even replacing technical components in automotive vehicles, side mirrors of modern automotive vehicles are replaced by camera monitoring systems, where one or more cameras are placed on the side wings of the vehicle and a respective monitor display is arranged within the cockpit of the vehicle in such a way that the driver can observe for example the traffic like with traditional side mirrors.

Thus, these displays (electronic mirrors (or e-mirrors)) of e-mirror systems comprising at least one camera and a display should be easy to integrate in the vehicle and always be visible for the vehicle driver under all environmental conditions like the influence of sunshine or the visibility at nighttime conditions.

### SUMMARY

Thus, a problem of the present disclosure may be stated as how to improve an electronic mirror system. In particular, a problem of the present disclosure may be stated as how to improve the integration of an electronic mirror in an automotive vehicle.

This object may be solved by the features of the independent claims. The dependent claims define examples.

A first aspect of the present disclosure refers to a vehicle window for an automotive vehicle. The vehicle window comprises a first transparent layer and at least a second transparent layer, wherein at least a first synthetical layer is arranged between the first transparent layer and the second transparent layer. Furthermore, at least one LED array is arranged between the first synthetical layer and the first transparent layer and covers at least a first area of the vehicle window. The LED array is configured to not emit light in a first operation mode and wherein the LED array is configured to at least partially emit light in at least a second operation mode.

By integrating a LED array in the vehicle window for an automotive vehicle, an improved e-mirror system can be deployed in various automotive vehicles. In particular, there is no mandatory need for automotive vehicles to provide an additional display for e-mirrors. Instead, any already existing glass component within an automotive vehicle which is suitable can be extended as explained in the first aspect of the present disclosure.

Thus, the material and manufacturing costs are reduced since already available components of an automotive vehicle can be re-used or enhanced. Furthermore, the user convenience and experience may be improved.

A second aspect of the present disclosure refers to a display system for an automotive vehicle, comprising a vehicle window according the first aspect and at least one control unit, wherein the control unit is configured to control the LED array at least partially.

A third aspect of the present disclosure refers to a method for controlling a vehicle window according to the first aspect or for controlling a display system according to the second aspect. The method comprises the steps of receiving at least one information, in particular at least one automotive related information, to be displayed, adjusting the received at least one information in that way, that it can be displayed on the LED array of the vehicle window, and controlling the LED array of the vehicle window in that way that the LED array displays the adjusted at least one information in the second operation mode.

A fourth aspect of the present disclosure refers to a computer program comprising instructions which, when the program is executed by a computer, cause the computer to carry out the method according to the third aspect.

A fifth aspect of the present disclosure refers to a machine-readable medium having stored thereon a set of instructions, which if performed by one or more processors, cause the one or more processors to carry out the method according to the third aspect.

A sixth aspect of the present disclosure refers to a method for manufacturing a vehicle window for an automotive vehicle. The method comprises the steps of arranging at least a first synthetical layer between a first transparent layer and at least a second transparent layer and arranging a LED array between the first synthetical layer and the first transparent layer in such a way that the LED array covers at least a first area of the vehicle window. Furthermore, the LED array is configured to not emit light in a first operation mode and is configured to at least partially emit light in at least a second operation mode.

A seventh aspect of the present disclosure refers to an automotive vehicle which comprises at least one of a vehicle window according to the first aspect, a display system according to the second aspect, a computer program according to the fourth aspect, a machine-readable medium according to the fifth aspect, a vehicle window manufactured according to the method of the sixth aspect. Furthermore, the automotive vehicle is configured to perform a method for controlling a vehicle window according to the third aspect alternatively or additionally.

### BRIEF DESCRIPTION OF THE DRAWINGS

Further details and advantages of the present disclosure can be taken from the following description of one or more embodiments in conjunction with the drawings, in which:

FIG. 1 is a schematic drawing depicting one or more examples of a vehicle window;

FIG. 2 is a first schematic drawing depicting one or more examples of a vehicle window during operation;

FIG. 3 is a second schematic drawing depicting one or more examples of a vehicle window during operation;

FIG. 4 is a third schematic drawing depicting one or more examples of a vehicle window during operation;

FIG. 5 is a schematic drawing depicting one or more examples of a display system;

FIG. 6 is a schematic flowchart depicting one or more examples of a method for controlling a vehicle window;

FIG. 7 is a schematic flowchart depicting one or more examples of a method for manufacturing a vehicle window; and

FIG. 8 is a schematic drawing depicting one or more examples of an automotive vehicle.

### DETAILED DESCRIPTION OF THE EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, apparatuses, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present disclosure, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present disclosure. As used herein, the term “and/or,” includes any and all combinations of one or more of the associated listed items. The phrase “at least one of” has the same meaning as “and/or”. As used herein the term “and/or” includes any and all combinations of one or more of the associated listed items and may be abbreviated as “/”.

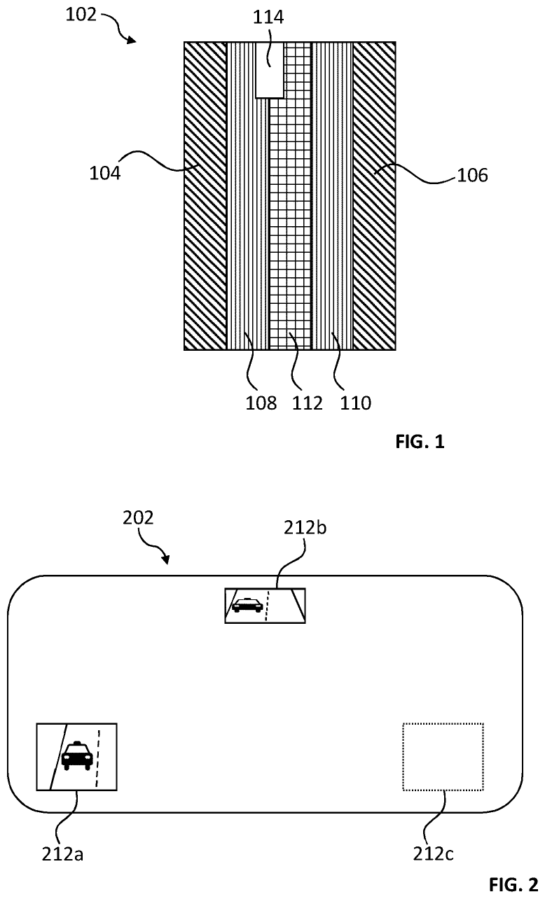

FIG. 1 is a schematic drawing depicting one or more examples of a vehicle window 102. The vehicle window 102 comprises a first transparent layer 104 and at least a second transparent layer 106. The transparent layers 104, 106 may be essentially designed as plane plates. The first transparent layer 104 and/or the second transparent layer 106 may be designed at least partially curved. The first and second transparent layer may be implemented as glass layer.

A first synthetical layer 108 is arranged between the first transparent layer 104 and the second transparent layer 106. The vehicle window 102 further comprises at least one LED array 112, which is arranged between the first transparent layer 106 and the first synthetical layer 108 and covers at least a first area of the vehicle window 102. In particular, the LED array 112 may also cover essentially the complete surface of the first transparent layer 106. Optionally, a second synthetical layer 110 may be arranged between the LED array 112 and the second transparent layer 106.

The first synthetical layer 108 and/or the second synthetical layer 110 may comprise at least one polymer, in particular Polyvenilybutyral (PVB). The first synthetical layer 108 and/or the second synthetical layer 110 may be designed essentially transparent. Thus, any user looking through the vehicle window 102 may not see or focus to the first synthetical layer 108 and/or second synthetical layer 110. In one or more examples the first synthetical layer 108 and/or second synthetical layer 110 may be designed as transparent film.

The LED array 112 is configured to not emit light in a first operation mode. Furthermore, the LED array 112 is configured to at least partially emit light in at least a second operation mode. The first operation mode may be state of the vehicle window where the LED array 112 is at least inactive, preferably off. Thus, the LED array 112 is essentially power-off during the first operation mode which saves electrical energy. In the second operation mode, the LED array 112 may receive at least a standby-current in such a way, that at least one LED of the LED array 112 emits light.

The vehicle window 102 and the area where the automotive related information is displayed may be configured to be essentially transparent in the first operation mode. Thus, any user of the vehicle window 102 may not essentially capture the LED array 112 directly. However, the vehicle window 102 may be configured to be less transparent to the user or driver in the first area of the vehicle window 102 in the second operation mode. This may entail that the transparency of the different layers and thus of the first area per se does not change, but in the second operating mode when the LED array is turned on, the light emitted by the array emitted in direction of the user/driver provides an impression to the user/driver as if the transparency has decreased, as less is visible from the environment outside the vehicle window compared to the situation when the LED array is not emitting light. Thus, when the LED array 112 is emitting light, the user may not look through the vehicle window 102 as such. Instead, the user's view may essentially focus on the emitted light of the LED array 112. However, it may be possible at least partially to see through the vehicle window 102 during the second operation mode.

The LED array 112 may comprise one or more micro-LEDs (mLEDs). Micro-LEDs may be smaller than 2 mm, preferably smaller than 1 mm, more preferably smaller than 0.8 mm. In one or more examples, the two adjacent LEDs may be separated by a pre-defined distance. The distance between two adjacent LEDs may be at least 1 mm, more preferably at least 2 mm.

In other embodiments of the disclosure, two adjacent LEDs may be separated by a distance which is in relation to the size, in particular diameter, of the two adjacent LEDs. Preferably, the distance between two adjacent LEDs may be essentially the same as the size, in particular diameter, of the two adjacent LEDs.

The vehicle window 102 may also comprise at least one control element 114. The control element 114 may be arranged in the vehicle window 102 to cover at least a part of the first transparent layer 104, the first synthetical layer 108 and/or the LED array 114. Alternatively or additionally, the control element 114 may be arranged in the vehicle window 102 to cover at least a part of the second transparent layer 106, the second synthetical layer 110 and/or the LED array 114.

FIG. 2 is a first schematic drawing depicting one or more examples of a vehicle window 202 during operation. In these examples, the vehicle window 202 may be designed as a windshield for an automotive vehicle. For this purpose, the vehicle window 202 may comprise at least three LED arrays 212a, 212b, 212c.

The first LED array 212a is arranged at the bottom left part of the vehicle window 202 and thus covers a first are of the vehicle window 202. As illustrated, the LED array 212a may be configured to display at least one information in the second operation mode. Preferably, the information may be related to any automotive specific information, also called automotive related information, which may be received from an image sensor of the vehicle, e.g. via a bus system, e.g. Control Area Network (CAN), Local Interconnect Network (LIN), FlexRay etc. According to the examples of FIG. 2, the LED array 212a displays at least a picture/image which captures the rearward traffic on the left side or right side of the vehicle analogue to a left side mirror or a right side mirror.

The first LED array 212a may also be configured to display several pictures sequentially, preferably the first LED array 212a may be configured to display a continuous and/or discontinuous video stream. Furthermore, any other information may be displayed via the first LED array 212a like time, date, speed or the like.

The second LED array 212b may be configured to display a view which is comparable to a rearview mirror and covers a second area in the upper part of the vehicle window 202 which is different to the first area of the vehicle window 202. Any video stream of the automotive vehicle which is configured to capture the rearview of the vehicle may be displayed.

The third LED array 212c may be arranged in the lower right corner of the vehicle window 202 and may cover a third area, which is different to the first area and the second area of the vehicle window 202. The third LED array 212c may be controlled independently of the first LED array 212a or the second LED array 212b as depicted in FIG. 2. The third LED array 212c is in the first operation mode and thus not emitting light. The operation mode of the third LED array 212c may be inactive or turned off.

A user of the vehicle window 202 may be able to look through the third LED array 212c. However, since the first LED array 212a and the second LED array 212b are in the second operation mode and thus emit light, a user of the vehicle window 202 may not look through the vehicle window 202 at the first and second area where the first LED array 212a and the second LED array 212b are arranged.

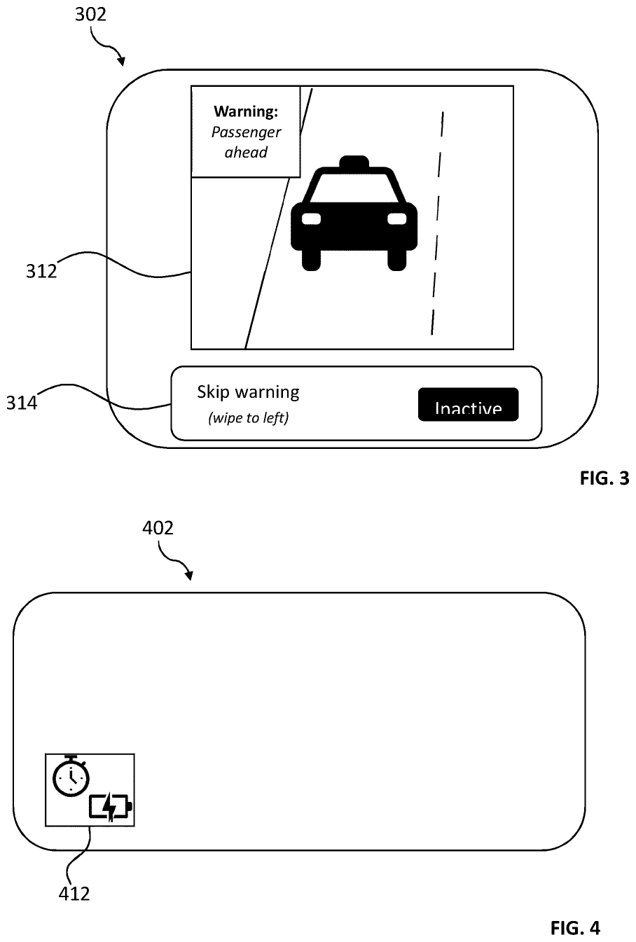

FIG. 3 is a second schematic drawing depicting one or more examples of a vehicle window 302 during operation. The LED array 312 displays a rearward view of an automotive vehicle. The rearward view may be based on a picture or a video stream captured by a capturing device of the automotive vehicle.

In this example, the LED array 312 is configured to display a picture or video stream and additionally a further information. The further information may be information related to the automotive vehicle, in which the vehicle window 302 may be deployed. The information may relate to any general information and/or high priority information like warnings or the like.

In the present example, the information relates to a warning that a passenger is ahead the automotive vehicle. For this purpose, the LED array 312 is configured to display both, the picture or video stream and the further information, namely the passenger warning alert. This may be realized with an overlay mode and/or picture-in-picture mode as illustrated in FIG. 3. Alternatively or additionally, it may be possible for the LED array 312 to display the information only.

The vehicle window 302 may further comprise at least one control element 314 which may be configured to at least partially control the LED array 312. The control element 314 may at least partially overlap with the LED array 312. By doing so, the control element 314 itself does not need any labeling. Instead, the part of the control element 314, which overlaps with the LED array 312 may serve as labeling of the control element 314.

In one or more examples, the control element 314 may be configured to determine at least one user input. Thus, the control element 314 may be designed as sensor determining a capacitive and/or inductive change induced by a contact of the user with the vehicle window 302, in particular in the area of the vehicle window 302, where the control element 314 is essentially arranged. Thus, the control element 314 may be configured to display a button or the like to request a user to give feedback. In other embodiments, the LED array 312 may be configured to display a button or the like and the control element 314 is configured to determine any user feedback in the area of the control element, where the LED array 312 displays the button. Alternatively or additionally, the control element 314 may be configured to determine at least one gesture of a user. For this purpose, the user may wipe or the like.

The user may switch the operation mode of the LED array 312 by utilizing the control element 314. Thus, the user may switch the LED array 312 between its first operation mode or its second operation mode. In order to feedback the user a determined user input, the control element 314 may be configured to provide haptic feedback to the user.

In these examples, the vehicle window 302 may be designed as a side window for an automotive vehicle. Alternatively, the vehicle window 302 may be also designed as a roof window or a rear window. The LED array 312 of the vehicle window 302 may be configured to emit light at least in the direction of the first transparent layer in the second operation mode. For this purpose, the first transparent layer of the vehicle window 302 may be directed towards the interior of the automotive vehicle during deployment in or at the automotive vehicle. The second transparent layer of the vehicle window 302 may face towards the exterior (environment) of the automotive vehicle during deployment in or at the automotive vehicle accordingly.

The LED array 312 may be designed to comprise at least a first layer with a first set of LEDs which are arranged in a plane. However, the LED array may also be designed as three-dimensional array comprising at least a second layer which is adjacent to the first layer of the LED array, wherein the second layer of the LED array comprises a second set of LEDs. Thus, any displayed 3D effect may be possible. Furthermore, a sidewise view of a user may be supported.

FIG. 4 is a third schematic drawing depicting one or more examples of a vehicle window 402 during operation.

In these examples, the first transparent layer of the vehicle window 402 may be directed towards the interior of the automotive vehicle during deployment in or at the automotive vehicle. The second transparent layer of the vehicle window 402 may face towards the exterior (environment) of the automotive vehicle during deployment in or at the automotive vehicle accordingly.

Alternatively or additionally to the examples of FIG. 3, the vehicle window 402 may be also configured to emit light at least in the direction of the second transparent layer in at least a third operation mode. Thus, any passenger or person, who is adjacent to the second transparent layer of the vehicle window 402 may be able to utilize the vehicle window 402. In these examples, the LED array 412 is designed to show a parking meter and additionally to show the present load state of the automotive vehicle in which the vehicle window 402 may be used.

Furthermore, the vehicle window 402 may comprise at least one control element (not shown) which is configured to determine at least one user feedback. Therefore, the control element may be configured to determine a touch gesture or the like on the second transparent layer of the vehicle window 402.

Alternatively or additionally, a first portion of LED array 412 may be configured to emit light essentially towards the first transparent layer and at least a second portion of LED array 412 may be configured to emit light essentially towards the second transparent layer. Preferably, this may be possible independently of each other, namely the first or second portion of the LED array 412. In one or more examples, a third portion of LED array 412 may be configured to emit light towards the first transparent layer and the second transparent layer, in particular simultaneously.

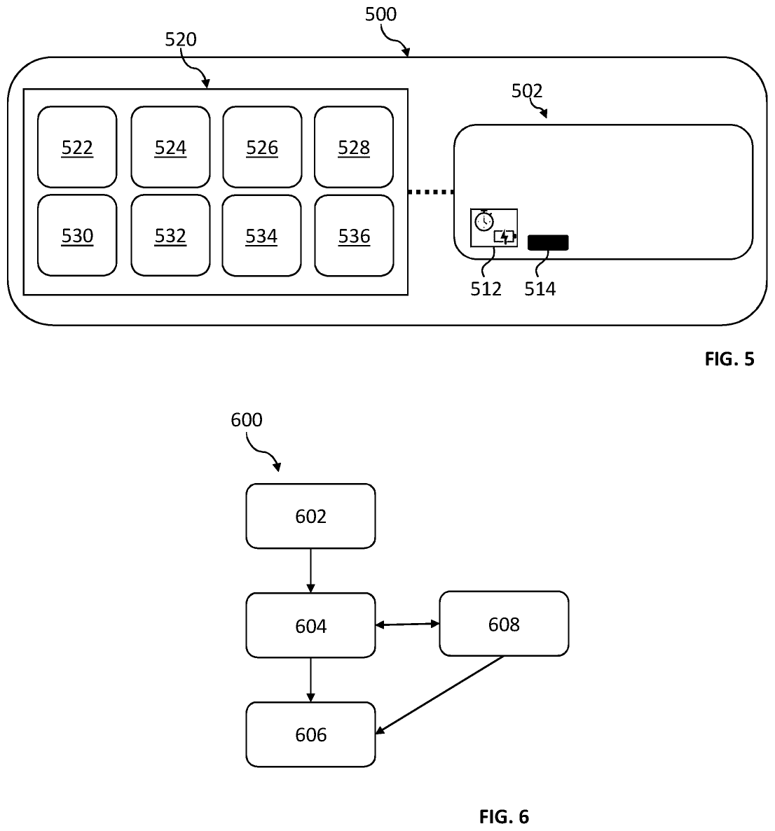

FIG. 5 is a schematic drawing depicting one or more examples of a display system 500. The display system 500 comprises the vehicle window 502 as well as a control unit 520 which is configured to control the LED array at least partially.

For this purpose, the control unit 520 may comprise one or more memories 522 which are configured to store at least temporarily, preferably permanently, any information, program code, or computer program to control the vehicle window 502, preferably its LED array 512, and more preferred the LED array 512 and a control element of the vehicle window accordingly.

The memory 522 may be configured to buffer a video stream of a first camera 526 or a second camera 528. In some examples the first camera 526 may be configured to capture a rearward view of the environment which is comparable to a side mirror view. The second camera 528 may be configured to capture a rearward view of the environment which is comparable to a rearview mirror view.

These captured images or video streams may be processed by a processing unit 524 which is configured to process any incoming image, video or other information to convert the data in such a way that they can be displayed via the one or more LED arrays 512 of the vehicle window 502. The processing unit 524 may be also configured to receive any other information data which are not captured or determined by the control unit 520.

Furthermore, the control unit 520 may comprise an interface 530 which is configured to transmit the converted data from the processing unit 524 towards the vehicle window 502, in particular to control the LED array 512. Additionally, the interface 530 may be also configured to receive any signal from a control element 514, which may be arranged in the vehicle window.

In some examples, the interface 530 may be configured to transmit and/or receive any data from other apparatuses, which are not part of the display system 500. For example, the interface 530 may exchange data via a bus-system of an automotive vehicle, e.g. a CAN-bus, a Lin-bus or FlexRay-bus.

Any data exchange may be wired or unwired. Therefore, the control unit 520 may comprise one or more antennas 532 which are configured to transmit and/or receive signals. Any signal connection between the control unit 520 and the vehicle window 502 may be realized at least by one of: an electromagnetic signal, an infrared signal, an electrical signal, or any other physical signal such as a pressure-based signal or the like.

The vehicle window 502 may be connected with the control unit 520 using at least one cable. Preferably, the connection is set up using at least two wires, wherein one wire is for power supply and the other wire is for signal exchange. However, the vehicle window 502 may be supplied with energy wirelessly. For this purpose, the control unit 520 may comprise a power supply 534 which is configured to supply electrical energy to the vehicle window 502. The electrical supply may be performed via inductive currents induced by the power supply 534.

The first camera 526 or the second camera 528 may be configured to capture at least partially a user of the vehicle window 502. Based on this, any user tracking may be realized to improve the usability of the vehicle window 502.

In some examples, an eye-tracking method is performed by the processing unit 524, which is processing the video stream of the first camera 526 and/or the second camera 528. Alternatively or additionally, the processing unit 524 may be also configured to perform a user gaze tracking method or even predict if and when a user of the vehicle window 502 may look towards the LED array 512 of the vehicle window 502. When the user gaze is detected as looking in direction of the location where the side mirror is located, the LED array and the displayed information may be turned on and if the user not looking in direction of the mirror any more, the LED array may be turned off, so that the displayed information also disappears. Furthermore, the processing unit 524 may also predict any probability that a user wants to execute any instruction via the control element 514.

The control unit 520 may control the LED array 512 of the vehicle window 502 in such a way, that, whenever the processing unit 524 predicts that the user will look towards the LED array 512, the LED array 512 will be switched from the first operation mode towards the second operation mode. Furthermore, whenever the user will look away from the LED array 512, the control unit 520 may be configured to control the LED array 512 to switch from the second operation mode to the first operation mode. Thus, the power consumption of the LED array 512 may be reduced significantly. This may be relevant at least for electrical vehicles, in which the display system 500 may be deployed.

However, the control unit 520 may be configured to control the LED array 512 by manually given instructions. A user may instruct the display system 500 via the control element 512 or any other control element of the display system 500 to amend the settings of the LED array 512. For example, the user may adjust at least one of: the brightness, the sharpness or the zoom of displayed information. Furthermore, the user may adjust whether the LED array 512 displays certain information like a video stream or alerts permanently or not.

The control unit 520 may be a local computer device (e.g. personal computer, laptop, tablet computer or mobile phone) with one or more processors 524 and one or more storage devices 522 or may be a distributed computer system (e.g. a cloud computing system with one or more processors and one or more storage devices distributed at various locations, for example, at a local client and/or one or more remote server farms and/or data centers). The control unit 520 may comprise any circuit or combination of circuits. The control unit 520 may include one or more processors 524 which can be of any type. As used herein, processor may correspond to any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA), or any other type of processor or processing circuit. Other types of circuits that may be included in the computer system may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems.

The control unit 520 may include one or more storage devices 522, which may include one or more memory elements suitable to the particular application, such as a main memory in the form of random-access memory (RAM), one or more hard drives, and/or one or more drives that handle removable media such as compact disks (CD), flash memory cards, digital video disk (DVD), and the like. The control unit 520 may also include a display device, one or more speakers, and a keyboard and/or controller, which can include a mouse, trackball, touch screen, voice-recognition device, or any other device that permits a system user to input information into and receive information from the computer system.

In one embodiment, the control unit 520 comprises a speech recognition unit 536 which is configured to determine at least one speech command of a user. The speech command may be used to control the LED array 512.

FIG. 6 is a schematic flowchart depicting one or more examples of a method 600 for controlling a vehicle window or a display system.

In a first step 602, at least one information is received which shall be displayed via the LED array of the vehicle window. This may be performed via an input device which provides at least raw data. The input device may be part of the vehicle window, the display system or may be any other device.

Afterwards, the received at least one information is adjusted 604 in that way, that it can be displayed on the LED array of the vehicle window. For this purpose, the processing unit of the display system or any other processing unit may be used. The adjustment may result due to an incompatible resolution of an inputted video stream which may not be displayed via the LED array directly. For this purpose, the processing unit may reduce, increase or adjust the parameter of the raw data accordingly. In a further step 606, the LED array of the vehicle window is controlled in that way that the LED array displays the adjusted at least one information.

The method 600 may receive 608 a user input which was determined by a control element of the vehicle window or the display system. The step of controlling the LED array 606 may be adapted accordingly. Furthermore, the step of adjusting 604 the received at least one information may be also aligned due to the received user input.

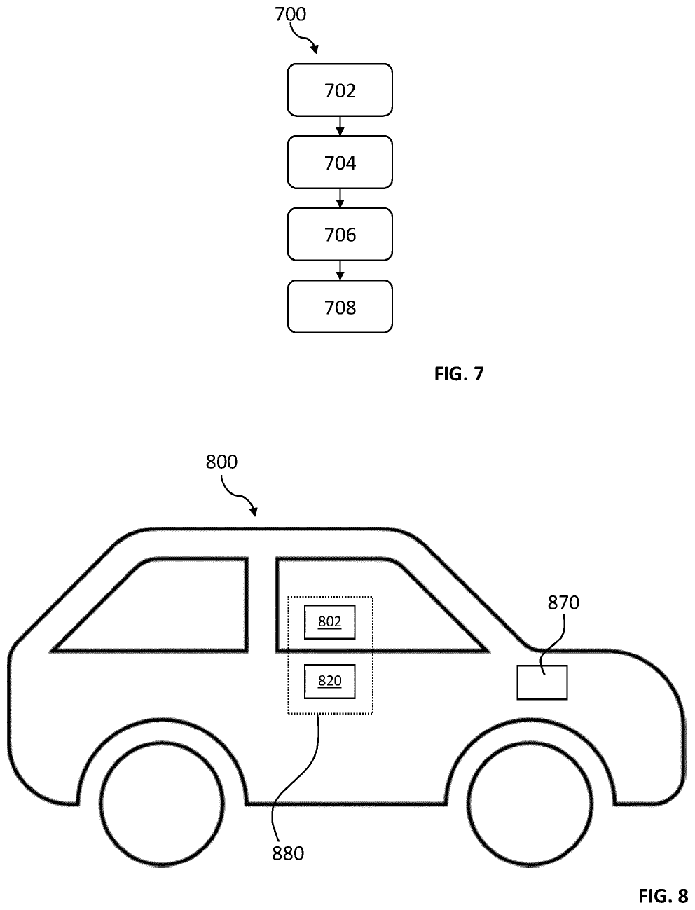

FIG. 7 is a schematic flowchart depicting one or more examples of a method 700 for manufacturing a vehicle window.

In a first step 702, at least a first synthetical layer is arranged between a first transparent layer and at least a second transparent layer. Afterwards, a LED array is arranged 704 between the synthetical layer and the first transparent layer in such a way that the LED array covers at least a first area of the vehicle window. According to the disclosure of the FIGS. 1 to 6, the LED array is configured to not emit light in a first operation mode and wherein the LED array is configured to at least partially emit light in at least a second operation mode.

In one or more embodiments of the method 700, a second synthetical layer may be arranged between the LED array and the second transparent layer. This may improve the break resistance of the vehicle window since the second synthetical layer may stabilize the vehicle window additionally.

In other embodiments of the method 700, a control element may be arranged 708 in the vehicle window. In particular, the control element may be arranged between the LED array and the first synthetical layer or the second synthetical layer. In some other examples, the control element may be arranged between the first synthetical layer and the first transparent layer or the second synthetical layer and the second transparent layer.

FIG. 8 is a schematic drawing depicting one or more examples of an automotive vehicle 800. The vehicle 800 comprises at least one vehicle window 802. However, the vehicle window 802 may be also part of a display system 880, which comprises also a control unit 820.

In addition, or alternatively, the vehicle may comprise a machine-readable medium 870 which is configured to perform the steps as given in FIG. 6 or performed by the control unit of the display system 880 and/or the vehicle window 802.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The application also relates to a display system comprising one or more processors and one or more storage devices. The display system is configured to: receive at least one information to be displayed, adjust the received at least one information in that way, that it can be displayed on the LED array of the vehicle window and to control the LED array of the vehicle window in that way that the LED array displays the adjusted at least one information. Furthermore, the display system may be configured to receive at least one user input form the control element of the vehicle window.

More details and aspects of the system are mentioned in conjunction with the proposed concept and/or the one or more examples described above or below (e.g. FIGS. 1-8). The system may comprise one or more additional optional features corresponding to one or more aspects of the proposed concept and/or of one or more examples described above or below.

Some embodiments relate to a system comprising one or more processors and one or more storage devices. The system is configured to: receive at least one information to be displayed, adjust the received at least one information in that way, that it can be displayed on the LED array of the vehicle window and to control the LED array of the vehicle window in that way that the LED array displays the adjusted at least one information. Furthermore, the system may be configured to receive at least one user input form the control element of the vehicle window.

More details and aspects of the system are mentioned in conjunction with the proposed concept and/or the one or more examples described above or below (e.g. FIGS. 1-8). The system may comprise one or more additional optional features corresponding to one or more aspects of the proposed concept and/or of one or more examples described above or below.

Some or all of the method steps may be executed by (or using) a hardware apparatus, like for example, a processor, a microprocessor, a programmable computer or an electronic circuit. In some embodiments, some one or more of the most relevant method steps may be executed by such an apparatus.

Depending on certain implementation requirements, embodiments of the disclosure can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the disclosure comprise a data carrier having electronically readable control signals, which are capable of cooperating with a programmable computer system, such that one of the methods described herein is performed. Other embodiments comprise the computer program for performing one of the methods described herein, stored on a machine-readable carrier.

In other words, an embodiment of the present disclosure is therefore a computer program having a program code for performing one of the methods described herein, when the computer program runs on a computer.

A further embodiment of the present disclosure is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present disclosure is an apparatus as described herein comprising a processor and the storage medium. Generally, examples of the present disclosure can be implemented as a computer program product with a program code, the program code being operative for performing one of the methods when the computer program product runs on a computer. The program code may, for example, be stored on a machine-readable carrier. For example, the computer program may be stored on a non-transitory storage medium. Some embodiments relate to a non-transitory storage medium including machine readable instructions, when executed, to implement a method according to the proposed concept or one or more examples described above.

A further embodiment of the disclosure is therefore a data stream or a sequence of signals representing the computer program for performing one of the methods described herein. The data stream or the sequence of signals may, for example, be configured to be transferred via a data communication connection, for example, via the internet.

A further embodiment comprises a processing device, for example, a computer or a programmable logic device, configured to, or adapted to, perform one of the methods described herein. A further embodiment comprises a computer having installed thereon the computer program for performing one of the methods described herein.

A further embodiment according to the disclosure comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

Embodiments may be based on using a machine-learning model or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g. sensor data, meta data and/or image data) may be preprocessed to obtain a feature vector, which is used as input to the machine-learning model.

Machine-learning models may be trained using training input data. The examples specified above use a training method called “supervised learning”. In supervised learning, the machine learning model is trained using a plurality of training samples, wherein each sample may comprise a plurality of input data values, and a plurality of desired output values, i.e. each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g. a classification algorithm, a regression algorithm or a similarity learning algorithm. Classification algorithms may be used when the outputs are restricted to a limited set of values (categorical variables), i.e. the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e. outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component. In some examples, the machine-learning algorithm may use a decision tree as a predictive model. In other words, the machine-learning model may be based on a decision tree. In a decision tree, observations about an item (e.g. a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may e.g. be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g. of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e. to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g. in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

From the above said some general conclusions can be drawn.

In one or more embodiments, the vehicle window is configured to be essentially transparent in the first operation mode and is configured to be at least partially nontransparent in the first area of the vehicle window in the second operation mode.

Thereby, the view of the user through the vehicle window can be limited on demand. Only when the user wants to or needs to receive emitted light of the LED array, the vehicle window can be nontransparent. Otherwise, if the vehicle window is not needed it may be unwanted for the user to be disturbed by the nontransparent vehicle window emitting light with its LED array.

In one or more embodiments, the LED array is configured to display at least one information in the second operation mode. The information is preferably at least one automotive related information and/or related to the automotive vehicle during operation in the automotive vehicle.

By doing so, the LED array may assist a user of the vehicle window by providing information. In one or more embodiments, the LED array may be configured to display at least a picture, preferably a video stream of a related automotive system. The automotive system may be a camera system which is configured to capture the environment comparable to a side mirror or rear mirror in an automotive vehicle.

In one or more embodiments, the information displayed by the LED array may be a warning information, in particular related with an automotive system. The automotive system may comprise a driver surveillance unit which is able to alert specific pre-defined situations. If the surveillance unit detects a microsleep of the driver, the driver may warn the driver via the LED array.

In one or more embodiments, the LED array may display an alert if a crash risk is predicted by an automotive system of the vehicle. In particular, any ADAS like an emergency brake assistant, a lane assistant and/or an autonomous cruise control system may be used for this purpose.

In one or more embodiments, the LED array is configured to display at least a picture, preferably a video stream, and an information determined by an automotive system in an overlay mode or picture-in-picture (PiP) mode. Thus, the LED array may inform a user by displaying more than one specific data.

In one or more embodiments, the LED array is configured to be in the second operation mode when the gaze of a user of the vehicle window or the display system directs to the LED array. In addition, it may be that the LED array is in the first operation mode when the gaze of the user of the vehicle window or the display system does not direct to the LED array.

Thus, any power consumption of the LED array can be reduced, in particular minimized since it may be used when it is actively requested by the user. Furthermore, the view of the user is not limited by the vehicle window if the user does not need to have displayed certain information by the LED array.

In one or more embodiments, a probability may be determined that the gaze of a user of the vehicle window is directing towards the LED array. Preferably, an eye tracking unit may be used for enhanced prediction of user behavior with regard to the user's gaze.

More preferably, the prediction of a user's gaze may be determined by a neuronal network, which may be trained by training data. Based on this, a more accurate probability of a user's gaze may be determined.

In one or more embodiments, it may be possible to adjust the vehicle window in that way that a user can assign when the LED array switches from a first operation mode to the second operation mode or vice versa. For this purpose, pre-defined values may be given for selection to enhance usability of the vehicle window. For example, it may be possible that a user can select whether the LED array is in the first or second operation mode continuously.

In one or more embodiments, the vehicle window is designed as at least one of: a windshield, a side window, a roof window or a rear window for an automotive vehicle. This implementation may be beneficial since already existing components of the automotive vehicle may be used or enhanced.

In one or more embodiments, the vehicle window is arranged in the front, side, back side or top side of an automotive vehicle during operation. Preferably, any standard glass component of an automotive vehicle may comprise a vehicle window.

In one or more embodiments, the LED array comprises one or more micro-LEDs. By reducing the size of the LEDs of the LED array, the transparency of the vehicle window may be improved. Furthermore, the view of the user through the vehicle window may not be limited by the LED array since the LEDs of the LED array may be not visible for the user's eye.

In one or more embodiments, the diameter of at least one LED of the LED array may be smaller than 2 mm, preferably smaller than 1 mm, more preferably smaller than 0.8 mm. Thus, the transparency of the vehicle window may be further improved.

In one or more embodiments, two adjacent LEDs of the LED array may be separated by a pre-defined distance, preferably by at least 1 mm, more preferably by at least 2 mm. The distance between two adjacent LEDs of the LED array may be in the range of the diameter of at least one LED of the LED array. This further improves the transparency of the vehicle window, since a user's eye may not focus on each LED of the LED array if the diameter of the LEDs is below a certain threshold and/or if the distance between two adjacent LEDs is beyond a specific threshold.

In one or more embodiments, the LED array is configured to emit light at least in the direction of the first transparent layer in the second operation mode. If the first transparent layer is directing to the interior of an automotive vehicle during operation, then a person within the interior of the vehicle may be able to see any specific information displayed via the LED array. Otherwise, if the first transparent layer is directing to the exterior of an automotive vehicle during operation, the environment, in particular other people, can see any specific information displayed via the LED array. For example, specific information may be displayed to the environment like whether the vehicle is charging or since when a vehicle is parking (parking meter). Alternatively or additionally, the displayed information may have a warning function if e.g. the vehicle is braking intensively, the environment can be informed more immersive.

In one or more embodiments, the LED array is configured to emit light in the direction of the first transparent layer and in the direction of the second transparent layer. Thus, the vehicle window is not limited to display information to the interior or exterior of a vehicle in operation. Furthermore, it may be possible to display first information for the interior of the vehicle and display second information, which is different from the first information, for the exterior of the vehicle during operation.

For this purpose, the LED array may comprise a first portion of LEDs which is configured to emit light essentially towards the first transparent layer and at least a second portion of LEDs which is configured to emit light essentially towards the second transparent layer. Preferably, the LED array may be configured to control whether the first portion of LEDs is in the second operation mode and/or whether the second portion of LEDs is in the second operation mode, preferably independently of each other. In one or more embodiments, the LED array may comprise a third portion of LEDs which are configured to emit light to the first transparent layer and the second transparent layer. The first, second and/or third portions of LEDs may be at least partially the same.

In one or more embodiments, at least one control element is integrated in the vehicle window, wherein the control element is configured to at least partially control the LED array. A control element in this context may be a capacitive or inductive sensor which is able to determine any movement of a user's body part, preferably a finger wipe on the vehicle window, to control the LED array accordingly. Alternatively or additionally, the control element may be configured to determine a gesture of a user to control the LED array.

In one or more embodiments, the control element is configured to reflect a captured user input with a haptic feedback. Thus, the user experience may be further improved.

In one or more embodiments, the LED array is designed to comprise at least a first layer with a first set of LEDs which are arranged in a plane. In other words, the LED array may be arranged as two-dimensional array. Thus, the appearance of displayed information via the LED array may be improved. In particular, any picture-related information like video streams may be easier viewable by a user of the vehicle window.

In one or more embodiments, the LED array may be designed as three-dimensional array comprising at least a second layer which is adjacent to the first layer of the LED array, wherein the second layer of the LED array comprises a second set of LEDs. Thus, also 3D effects may be displayable with the LED array.

In one or more embodiments, a second synthetical layer may be arranged between the LED array and the second transparent layer. Thus, the vehicle window is more robust against any impacts resulting from highway stones or the like.

In one or more embodiments, at least one control element may be arranged between the LED array and the first transparent layer or the second transparent layer. Preferably, the control element may be arranged between the LED array and the first synthetical layer or the second synthetical layer. The control element may be configured to at least partially control the LED array.

It is to be understood that the disclosure can be carried out by specifically different equipment and devices, and that various modifications, both as to the equipment details, deep models and imaging and data analytics and operating procedures, can be accomplished without departing from the scope of the disclosure.

Generally, embodiments of the present disclosure can be implemented as a computer program product with a program code, the program code being operative for performing one of the methods when the computer program product runs on a computer. The program code may, for example, be stored on a machine-readable carrier.

Although the present disclosure has been described in detail with reference to the preferred embodiment, the disclosure is not limited by the disclosed examples. Even if example embodiments are described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A vehicle window for an automotive vehicle, comprising:
a first transparent layer;
at least a second transparent layer;
at least a first synthetical layer, which is arranged between the first transparent layer and the at least the second transparent layer; and
at least one light emitting diode (LED) array, which is arranged between the first synthetical layer and the first transparent layer and covers at least a first area of the vehicle window,
wherein the at least one LED array is configured to not emit light in a first operation mode and wherein the at least one LED array is configured to at least partially emit light in at least a second operation mode.

2. The vehicle window of claim 1, wherein the at least first area is configured to be essentially transparent for a user of the vehicle window in the first operation mode and to be less transparent in the at least first area of the vehicle window in the second operation mode than in the first operating mode.

3. The vehicle window of claim 1, wherein the at least one LED array is configured to display at least one information, in particular at least one automotive related information, in the second operation mode.

4. The vehicle window of claim 1, wherein the at least one LED array is configured to be in the second operation mode when a gaze of a user of the vehicle window directs to the LED array.

5. The vehicle window of claim 1, wherein the vehicle window is formed as at least one of: a windshield, a side window, a roof window and a rear window for the automotive vehicle.

6. The vehicle window of claim 1, wherein the at least one LED array comprises one or more micro-LEDs.

7. The vehicle window of claim 1, wherein the at least one LED array is configured to emit light at least in a direction of the first transparent layer (104) in the second operation mode.

8. The vehicle window of claim 1, wherein at least one control element is integrated in the vehicle window, wherein the at least one control element is configured to at least partially control the at least one LED array.

9. The vehicle window of claim 1, wherein the at least one LED array comprises at least a first layer with a first set of LEDs which are arranged in a plane.

10. A display system for the automotive vehicle comprising the vehicle window according to claim 1 and at least one control unit, wherein the at least one control unit is configured to at least partially control the at least one LED array.

11. A method for controlling a vehicle window according to claim 1, comprising the steps of:
receiving at least one information, in particular at least one automotive related information, to be displayed;
adjusting the received at least one information for display on the at least one LED array of the vehicle window; and
controlling the at least one LED array of the vehicle window such that the at least one LED array displays the adjusted at least one information in the second operation mode.

12. A computer program comprising instructions which, when the computer program is executed by a computer, causes the computer to carry outperform the method of claim 11.

13. A computer-program product embodied in a non-transitory computer readable medium that is programmed and executable by one or more processors, the computer-program product comprising instructions to execute the method of claim 11.

14. A method for manufacturing a vehicle window for an automotive vehicle, the method comprising: arranging at least a first synthetical layer between a first transparent layer and at least a second transparent layer; and
arranging a LED array between the at least the first synthetical layer and the first transparent layer such that the LED array covers at least a first area of the vehicle window, wherein the LED array is configured to not emit light in a first operation mode and wherein the LED array is configured to at least partially emit light in at least a second operation mode.

15. An automotive vehicle comprising a vehicle window according to claim 1.

16. A vehicle window for an automotive vehicle, the vehicle window comprising:
a first transparent layer;
a second transparent layer;
a first synthetical layer positioned between the first transparent layer and the second transparent layer; and
at least one light emitting diode (LED) array arranged between the first synthetical layer and the first transparent layer that covers at least a first area of the vehicle window,
wherein the at least one LED array is configured to not emit light in a first operation mode and wherein the at least one LED array is configured to at least partially emit light in at least a second operation mode.

17. The vehicle window of claim 16, wherein the at least first area is configured to be essentially transparent for a user of the vehicle window in the first operation mode and to be less transparent in the at least first area of the vehicle window in the second operation mode than in the first operating mode.

18. The vehicle window of claim 16, wherein the at least one LED array is configured to display at least one information, in particular at least one automotive related information, in the second operation mode.

19. The vehicle window of claim 16, wherein the at least one LED array is configured to be in the second operation mode when a gaze of a user of the vehicle window directs to the LED array.

20. The vehicle window of claim 16, wherein the vehicle window is formed as at least one of: a windshield, a side window, a roof window and a rear window for the automotive vehicle.
